(19) United States
(12) Patent Application Publication
(10) Pub. No.: US 2026/0065684 A1
(43) Pub. Date: Mar. 5, 2026

(54) METHOD OF LOCALIZING HEADS OF PEOPLE IN CROWD AND COMPUTER PROGRAM RECORDED ON RECORDING MEDIUM TO EXECUTE THE SAME

(71) Applicant: INFINIQ Co., Ltd., Seoul (KR)

(72) Inventors: Ji Hye RYU, Gimpo-si (KR); Kwang Ho SONG, Seoul (KR); Jun Hyung PARK, Suwon-si (KR); Seung Taek KIM, Gwangmyeong-si (KR); Gene CHOI, Seoul (KR)

(73) Assignee: INFINIQ Co., Ltd., Seoul (KR)

(21) Appl. No.: 19/299,113

(22) Filed: Aug. 13, 2025

(30) Foreign Application Priority Data
Aug. 28, 2024 (KR) 10-2024-0116214

(51) Int. Cl. G06V 20/52; G06T 7/60

(52) U.S. Cl. CPC G06V 20/53; G06T 7/60

(57) ABSTRACT

The present invention proposes a method of localizing heads of people in a crowd, which is capable of localizing heads of people in a crowd appearing in an image captured by a camera with high accuracy. The method may include performing label assignment to train the AI model. The matching is performed in ascending order of a difference in probability of the head being present at a predicted point predicted from the AI model based on a distance IoU loss value between the anchor point and the ground truth points, and the anchor point. The present invention was carried out with the support of the Civil-Military Technology Cooperation Project conducted by the Civil-Military Cooperation Promotion Agency with funds from the government of the Republic of Korea (Ministry of Trade, Industry and Energy and Defense Acquisition Program Administration) (Project No. 23-CM-Al-15).

### CROSS-REFERENCE TO RELATED APPLICATION

This application claims the benefit of and priority to Korean Patent Application No. 10-2024-0116214, filed on Aug. 28, 2024, the entire disclosure(s) of which is hereby incorporated herein by reference in its entirety.

### TECHNICAL FIELD

The present invention relates to artificial intelligence (AI). More specifically, the present invention relates to a method for localizing heads of peoples in a crowd that is capable of localizing heads of people in a crowd appearing in an image captured by a camera with high accuracy, and a computer program recorded on a recording medium to execute the same.

### BACKGROUND

A closed circuit television (CCTV) is a security camera that is installed for safety purposes, such as crime prevention, surveillance, and fire prevention. The CCTVs are installed in crime-prone areas, inside of buildings, outside of buildings, elevators, subways, and the like to acquire videos of such places.

With the recent increase in importance of crime prevention, facility safety, and fire prevention, a large number of CCTVs are being installed everywhere, to the extent that there are no areas left without CCTV coverage.

However, the lack of personnel to control the large number of CCTVs hinders appropriate response to accidents when the accidents occur. In particular, the lack of personnel has led to inadequate initial response, resulting in major disasters despite the fact that a CCTV control center operated by the police, fire department, the Ministry of the Interior and Safety, or the like transmits images before and after an incident.

To address such an issue, various artificial intelligence models capable of predicting crowd density in a video captured by the CCTV have been recently developed. In particular, a regression model for directly predicting the number of people appearing in a video, and a density map estimation model for generating a Gaussian distribution image obtained by measuring the density of people appearing in the video have been proposed.

However, the proposed artificial intelligence models have a significant error between actual and predicted values and cannot determine accurate positions of people in a video, making it difficult to discriminate crowd density from a video of a crowded area. The present invention was carried out with the support of the Civil-Military Technology Cooperation Project conducted by the Civil-Military Cooperation Promotion Agency with funds from the government of the Republic of Korea (Ministry of Trade, Industry and Energy and Defense Acquisition Program Administration) (Project No. 23-CM-Al-15).

### PRIOR ART DOCUMENT

### Patent Document

(Patent Document 1) Korean Patent Publication No. 10-1888308, titled “Intelligent CCTV Control System,” (Published on Aug. 7, 2018)

### SUMMARY

An object of the present invention is to provide a method of localizing heads of people in a crowd, which is capable of localizing heads of people in a crowd appearing in an image captured by a camera with high accuracy.

Another object of the present invention is to provide a computer program recorded on a recording medium to execute the method of localizing heads of people in a crowd capable of localizing heads of people in a crowd appearing in an image captured by a camera with high accuracy.

The objects of the present invention are not limited to the objects mentioned above, and other object that are not mentioned will be clearly understood by those skilled in the art from the description below.

To achieve the objects as described above, the present invention proposes a method of localizing heads of people in a crowd, which is capable of localizing heads of people in a crowd appearing in an image captured by a camera with high accuracy. The method includes training, by a detection server, an artificial intelligence (AI) model; receiving, by the detection server, an image captured by a camera requiring head localization; and detecting, by the detection server, center coordinates of a head of at least one person from the received image based on the artificial intelligence model. Specifically, the training includes matching at least one anchor point for a center of a grid formed by dividing a training image into equal-sized areas to a plurality of ground truth points for a center of a head of a person appearing in the training image and performing label assignment to train the artificial intelligence model, non-replacement matching being performed in ascending order of a difference in probability of the head being present at a predicted point predicted from the artificial intelligence model based on a distance IoU (DIoU) loss value between the at least one anchor point and the plurality of ground truth points, and the anchor point.

The training includes performing matching by extracting in a non-replacement manner an anchor point with a smallest difference in the probability of the head being present at the predicted point predicted from the artificial intelligence model based on a distance IoU (DIoU) loss value between at least one of already matched anchor points and the ground truth point failing to be matched and the anchor point, when the ground truth point fails to be matched with the at least one anchor point.

The training includes matching the at least one anchor point to the plurality of ground truth points based on a cost matrix according to the following formula.

$$\begin{matrix}M ( 𝔸 , 𝔾 ) = {ℒ}_{DIoU} ( 𝔸 , 𝔾 ) - {\hat{P}}_{j} \\ = 1 - IoU ( {B}_{j}^{𝔸} , {B}_{i}^{𝔾} ) + \frac{{‖ {A}_{j} - {G}_{i} ‖}_{2}}{{d}^{2}} - {\hat{P}}_{j}\end{matrix} \qquad [ Formula ]$$

(where [symbol] is the ground truth point, [symbol] is the anchor point, \hat{P}ⱼ is the probability of the head being present at the predicted point predicted from the artificial intelligence model based on the anchor point, Aⱼ is a set of a plurality of anchor points, Gᵢ is a set of the plurality of ground truth points, [symbol] is a set of anchor point bounding boxes, [symbol] is a set of ground truth point bounding boxes, and d is a value obtained by converting a diagonal distance between a bounding box of the ground truth points and a bounding box of the anchor points into a Euclidean distance.)

The training includes dividing the anchor points into a positive anchor point matched with the ground truth point and a negative anchor point not matched with the ground truth point, and training the artificial intelligence model based on the positive anchor point and the negative anchor point.

The training includes assigning labels for a length of the bounding box of the ground truth point, one-hot encoding of the probability of the head being present at the predicted point predicted from the artificial intelligence model based on the positive anchor point, and centerness between the ground truth point and a positive anchor point to the positive anchor point.

The training includes calculating the centerness based on the following formula.

$${C}^{*} = 1 - \frac{{‖ {A}_{j} - {G}_{i} ‖}_{2}}{{d}^{2}} \qquad [ Formula ]$$

(Aⱼ is a set of the plurality of anchor points, Gᵢ is a set of the plurality of ground truth points, and d is a value obtained by converting a diagonal distance between the bounding box of the ground truth points and the bounding box of the anchor points into a Euclidean distance.)

The training includes assigning a label for one-hot encoding of the probability of the head being present at the predicted point predicted from the artificial intelligence model based on the negative anchor point to the negative anchor point.

The artificial intelligence model constructs a feature pyramid structure by gradually downscaling feature maps extracted from each frame of the received image by a preset scaling ratio, and fuses scale-specific features contained in the feature maps included in the feature pyramid structure into a feature map having a preset size for the received image through convolution, dilation, and sum operations.

The detecting includes estimating the center coordinates of the head of the at least one person in the received image based on distances between left, right, upper, and lower boundaries of a bounding box set for an object predicted to be a head of a person from a plurality of anchor points in the received image, a probability of the head being present at the predicted point corresponding to a center point of the bounding box set for the object predicted to be the head of the person, and centerness between the predicted point and the anchor point.

The detecting includes calculating a score of the predicted point based on the following formula, and estimating the center coordinates of the head of the at least one person in the received image based on the calculated score of the predicted point.

$$score = \hat{P} \times \sqrt{\hat{C}} \qquad [ Formula ]$$

(where \hat{P} is the probability and Ĉ is the centerness)

To achieve the objects as described above, the present invention proposes a computer program recorded on a recording medium to execute the method of localizing heads of people in a crowd, which is capable of localizing heads of people in a crowd appearing in an image captured by a camera with high accuracy. The computer program is connected to a computing device comprising: a memory, a transceiver, and a processor configured to process instructions residing in the memory, the computer program being a computer program recorded on a recording medium to cause the processor to execute: training an artificial intelligence (AI) model; receiving an image captured by a camera requiring head localization; and detecting center coordinates of a head of at least one person from the received image based on the artificial intelligence model, wherein the training includes matching at least one anchor point for a center of a grid formed by dividing a training image into equal-sized areas to a plurality of ground truth points for a center of a head of a person appearing in the training image and performing label assignment to train the artificial intelligence model, non-replacement matching being performed in ascending order of a difference in probability of the head being present at a predicted point predicted from the artificial intelligence model based on a distance IoU (DIoU) loss value between the at least one anchor point and the plurality of ground truth points, and the anchor point.

According to embodiments of the present invention, it is possible to localize heads of people in a crowd appearing in an image captured by a camera through a pre-trained artificial intelligence model, thereby accurately determining crowd density for an image of a crowded area.

The effects of the present invention are not limited to those mentioned above, and other effects that are not mentioned will be clearly understood by those skilled in the art from the description of the claims.

### BRIEF DESCRIPTION OF THE DRAWINGS

FIG. 1 is a block diagram illustrating a system for localizing heads of people in a crowd according to an embodiment of the present invention.

FIG. 2 is a logical configuration diagram illustrating a detection server according to the embodiment of the present invention.

FIG. 3 is an illustrative diagram illustrating a label assignment process according to an embodiment of the present invention.

FIG. 4 is an illustrative diagram illustrating an artificial intelligence model according to an embodiment of the present invention.

FIG. 5 is an illustrative diagram illustrating an output value estimated from the artificial intelligence model according to the embodiment of the present invention.

FIGS. 6 to 8 are illustrative diagrams illustrating performance of the artificial intelligence model according to the embodiment of the present invention.

FIG. 9 is a hardware configuration diagram illustrating the detection server according to the embodiment of the present invention.

FIG. 10 is a flowchart illustrating a method of localizing heads of people in a crowd according to an embodiment of the present invention.

### DETAILED DESCRIPTION

It should be noted that the technical terms used herein are used merely to describe specific embodiments and are not intended to limit the present invention. Further, the technical terms used herein should be construed in the sense generally understood by those skilled in the art and should not be construed in an overly broad or overly narrow sense unless specifically defined otherwise herein. Further, when a technical term used herein is incorrect and fails to accurately express the spirit of the present invention, the term should be replaced with a technical term that can be correctly understood by those skilled in the art. Further, general terms used herein should be construed according to dictionary definitions or according to the context, and should not be construed in an excessively narrow sense.

Further, singular expressions used herein include plural expressions unless the context clearly indicates otherwise. In this application, terms such as “configured” or “have” should not be construed to necessarily include all components or steps described in the specification, and should be construed to mean that some of the components or steps may not be included or that additional components or steps may be included.

Further, terms including ordinal numbers, such as “first” and “second,” used herein may be used to describe various components, but the components should not be limited by these terms. These terms are used solely to distinguish one component from another. For example, a first component may be referred to as a second component without departing from the scope of the present invention, and similarly, a second component may also be referred to as a first component.

When a component is referred to as being “connected” or “coupled” to another component, the component may be directly connected or coupled to the other component, but there may also be other components in between. On the other hand, when a component is referred to as being “directly connected” or “directly coupled” to another component, it should be understood that there are no other intervening components.

Hereinafter, preferred embodiments of the present invention will be described in detail with reference to the accompanying drawings, and identical or similar components will be denoted by the same reference numerals regardless of the drawings, and redundant descriptions thereof will be omitted. Further, detailed description of related known technologies will be omitted when the description is deemed to obscure the gist of the present invention. Further, it should be noted that the accompanying drawings are intended solely to facilitate understanding of the present invention and should not be construed as limiting the present invention. The present invention should be construed to extend to all changes, equivalents, and alternatives, in addition to the accompanying drawings.

Meanwhile, the lack of personnel to control the large number of CCTVs hinders appropriate response to accidents when the accidents occur. In particular, the lack of personnel has led to inadequate initial response, resulting in major disasters despite the fact that a CCTV control center operated by the police, fire department, the Ministry of the Interior and Safety, or the like transmits images before and after an incident.

To address such an issue, various artificial intelligence models capable of predicting crowd density in an image captured by the CCTV have been recently developed. In particular, a regression model for directly predicting the number of people appearing in an image, and a density map estimation model for generating a Gaussian distribution image obtained by measuring the density of people appearing in the image have been proposed.

However, the proposed artificial intelligence models have a significant error between actual and predicted values and cannot determine accurate positions of people in an image, making it difficult to discriminate the crowd density from an image of a crowded area.

To overcome these limitations, the present invention is intended to propose various means for localizing heads of people in a crowd appearing in an image captured by a camera with high accuracy.

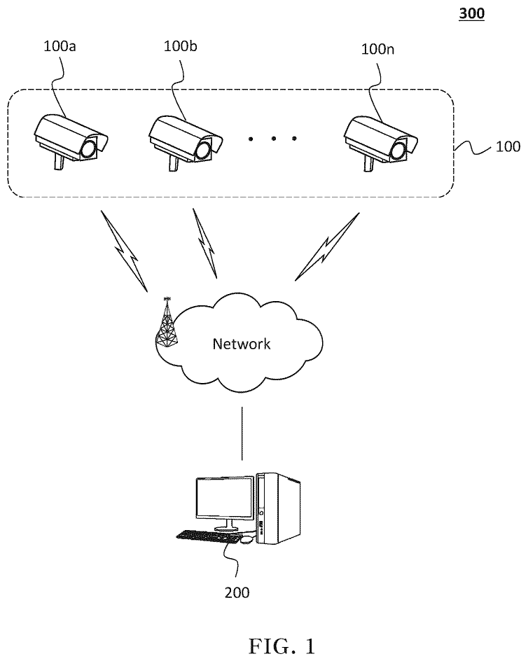

FIG. 1 is a schematic diagram illustrating a system for localizing heads of people in a crowd according to an embodiment of the present invention.

As illustrated in FIG. 1, the system for localizing heads of people in a crowd 300 according to an embodiment of the present invention may include a plurality of video collection devices 100a, 100b, . . . , 100n (100) and a detection server 200.

Thus, components of the system for localizing heads of people in a crowd 300 according to the embodiment of the present invention merely represent functionally distinct elements, and therefore, two or more of the components may be implemented in an integrated form in an actual physical environment, or a single component may be implemented in a divided form in the actual physical environment.

The respective components will be described: the video collection device 100 is installed in a specific area to acquire images. Specifically, the video collection device 100 may acquire an image obtained by photographing at least one person within the specific area using a camera.

For example, the video collection device 100 may be a closed circuit television (CCTV) installed in a crime-prone area, inside a building, outside a building, in an elevator, or in a subway, or the like, to be able to acquire images of such a place for safety purposes such as crime prevention, surveillance, and fire prevention.

The video collection device 100 may be a ½″ Charge Coupled Device (CCD), ⅓″ CCD, ¼″ CCD, or the like depending on elements, may be a dome camera, bullet camera, housing camera, a Pan Tilt Zoom (PTZ) camera, or the like depending on forms, and may be a fixed camera, speed dome camera, pan tilt zoom camera, or the like depending on functions.

The video collection device 100 may transmit the captured image to the detection server 200 in real time.

As a next configuration, the detection server 200 may localize heads of people in a crowd appearing in the captured image from the video collection device 100 with high accuracy.

Specifically, the detection server 200 may train an artificial intelligence (AI) model, receive an image captured by a camera that requires localization heads of people, and detect center coordinates of a head of at least one person from the received image based on the artificial intelligence model.

Meanwhile, detailed description of the detection server 200 according to the embodiment of the invention will be described hereinafter with reference to the drawings.

The detection server 200 may be any fixed computing device such as a desktop computer, workstation, or server, but is not limited thereto.

The video collection device 100 and the detection server 200 may transmit and receive data using a network that is a combination of one or more of a secure line, a public wired communication network, and a mobile communication network that directly connects devices. For example, the public wired communication network may include, but is not limited to, Ethernet, a digital subscriber line (x digital subscriber line: xDSL), a hybrid fiber coax (HFC), and a fiber to the home (FTTH). Further, the mobile communication network may include, but is not limited to, code division multiple access (CDMA), wideband code division multiple access (WCDMA), high-speed packet access (HSPA), long term evolution (LTE), and 5th generation mobile telecommunication.

Hereinafter, a logical configuration of the detection server according to an embodiment of the present invention will be described in detail.

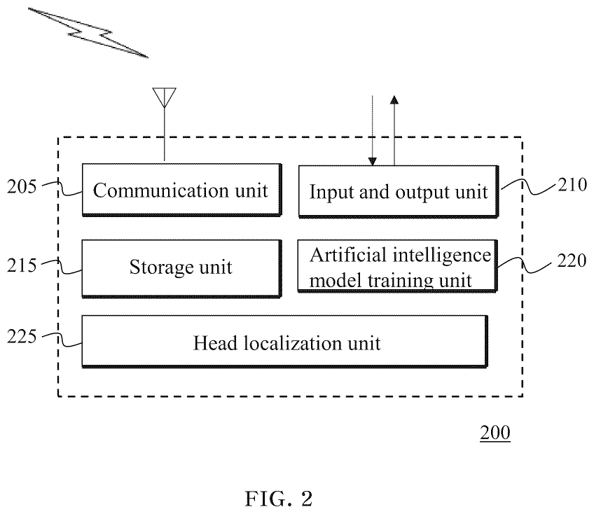

FIG. 2 is a logical configuration diagram illustrating the detection server according to the embodiment of the present invention.

Referring to FIG. 2, the detection server 200 according to an embodiment of the present invention may include a communication unit 205, an input and output unit 210, a storage unit 215, an artificial intelligence model training unit 220, and a head localization unit 225.

Since these components of the detection server 200 merely represent functionally distinct elements, two or more components may be implemented in an integrated form in an actual physical environment, or a single component may be implemented in a divided form in the actual physical environment.

The respective components will be described: the communication unit 205 may transmit and receive data to and from the video collection device 100. Specifically, the communication unit 205 may receive real-time images from the video collection device 100.

As a next configuration, the input and output unit 210 may localize the heads of the people in the crowd from the image received through the communication unit 205 and receive various types of configuration information for predicting crowd density. Additionally, the input and output unit 210 may display a processed image for monitoring the crowd density based on analysis results.

As a next configuration, the storage unit 215 may localize the heads of the people in the crowd from the received image, and store an artificial intelligence model for predicting the crowd density, and a data set for training the artificial intelligence model.

As a next configuration, the artificial intelligence model training unit 220 may train an artificial intelligence (AI) model for localizing a head of a person.

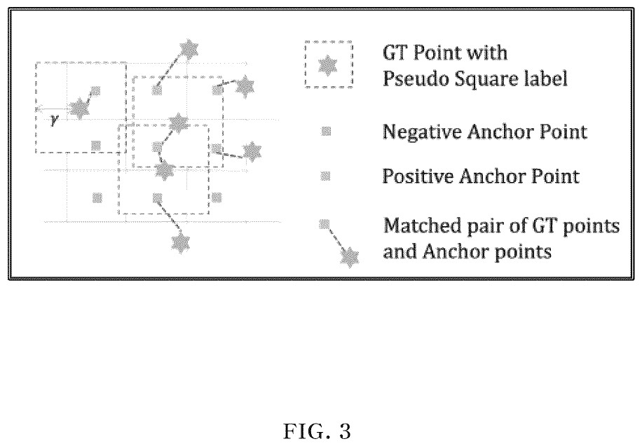

An artificial intelligence model training process according to an embodiment of the present invention will be described in detail with reference to FIG. 3.

FIG. 3 is an illustrative diagram illustrating a label assignment process according to an embodiment of the present invention.

The artificial intelligence model training unit 220 may perform a label assignment process of matching at least one anchor point for a center of a grid formed by dividing the training image into equal-sized areas to a plurality of ground truth points for a center of a head of a person appearing in the training image.

Here, the artificial intelligence model training unit 220 may perform non-replacement matching in ascending order of a difference in a probability of a head being present at the predicted point predicted from the artificial intelligence model based on a distance IoU (DIoU) loss value between at least one anchor point and a plurality of ground truth points, and the anchor point. In this case, when the ground truth point fails to be matched with at least one anchor point, the artificial intelligence model training unit 220 may perform matching by extracting in a non-replacement manner an anchor point with a smallest difference in the probability of the head being present at the predicted point predicted from the artificial intelligence model based on a distance IoU (DIoU) loss value between at least one of already matched anchor points and the ground truth point failing to be matched and the anchor point.

That is, the artificial intelligence model training unit 220 may match at least one anchor point with a plurality of ground truth points based on a cost matrix according to the following formula.

$$\begin{matrix}M ( 𝔸 , 𝔾 ) = {ℒ}_{DIoU} ( 𝔸 , 𝔾 ) - {\hat{P}}_{j} \\ = 1 - IoU ( {B}_{j}^{𝔸} , {B}_{i}^{𝔾} ) + \frac{{‖ {A}_{j} - {G}_{i} ‖}_{2}}{{d}^{2}} - {\hat{P}}_{j}\end{matrix} \qquad [ Formula ]$$

(where [symbol] is the ground truth point, [symbol] is the anchor point, \hat{P}ⱼ is a probability of the head being present at the predicted point predicted from the artificial intelligence model based on the anchor point, Aⱼ is a set of a plurality of anchor points, Gᵢ is a set of a plurality of ground truth points, [symbol] is a set of anchor point bounding boxes, [symbol] is a set of ground truth point bounding boxes, and d is a value obtained by converting a diagonal distance between a bounding box of the ground truth points and a bounding box of the anchor points into a Euclidean distance.)

Meanwhile, a radius γ of the inscribed circle of the bounding box of the ground truth point is a hyperparameter that can be changed depending on a video filming environment. The bounding box of the anchor points may be the grid described above.

Further, the artificial intelligence model training unit 220 may distinguish between a positive anchor point matched with the ground truth point and a negative anchor point not matched with the ground truth point based on matching results, and train the artificial intelligence model based on the distinguished positive and negative anchor points.

The above-described process may be expressed in pseudocode as follows.

Algorithm 1 Algorithm for Partial Many-to-One Matching

```
Require: N is the number of samples in an batch; / is the
number of the GT points in an image: / is the number
of the predictions in an image: [symbol]  is the set of GT, [symbol]  ϵ [symbol]
  ; [symbol]  is the set of PSL of the [symbol]  ; [symbol]  is Anchor points
  of Responsible Grid, [symbol]  ϵ [symbol]  ; [symbol]  is the set of PSL of
  the [symbol]  ; \hat{P}ⱼ is probability map of an image, \hat{P}ⱼ ϵ [symbol]  ; D
  is a function that calculates the DIoU loss between two
  input boxes; H is a function that associates the two input
  matrices
Ensure: X is a set of matched index of predictions; Y is a set
  of matched index of GT
1: X ← ∅
2: Y ← ∅
3: for 0 ≤ n ≤ N do
4: let m_{d} be the pair-wise D of [symbol]
  and [symbol] , m_{d} ϵ [symbol]
5. let mₚ be the pair-wise matrix of
\hat{P}ⱼ by Gᵢ, mₚ ϵ [symbol]
6: M ← m_{d} - mₚ
7: x, y ← H(M)
8: ind_x, ind_y ← where (D( [symbol]  , G_{y}) ≥ 2) [symbol]  The
maximum of DIoU is 2
9: for 0 ≤ ix, iy ≤ ind_x, ind_y, do
10: y_{iy} ← argmin(Mᵢₓ)
11: end for
12: X = X U x
13: Y = Y U y
14: end for
15: return X, Y
```

Meanwhile, the artificial intelligence model training unit 220 may perform conversion into a virtual square bounding box centered on a given ground truth point. In this case, the converted bounding box may be a virtual ground truth label (soft label) rather than a ground truth label assigned directly by a human (hard label). The artificial intelligence model training unit 220 may train the artificial intelligence model based on weak supervision using the soft label. Detailed description of the artificial intelligence model and prediction of the virtual bounding box and the center coordinates using the artificial intelligence model will be given later.

To this end, the artificial intelligence model training unit 220 may assign three types of labels to the matched positive anchor points.

Specifically, the artificial intelligence model training unit 220 may assign labels for a length of the bounding box of the ground truth point, one-hot encoding of the probability of the head being present at the predicted point predicted from the artificial intelligence model based on the positive anchor point, and centerness between the ground truth point and a positive anchor point to the positive anchor point.

Further, the artificial intelligence model training unit 220 may assign the label for the one-hot encoding of the probability of the head being present at the predicted point predicted from the artificial intelligence model based on the negative anchor point to the negative anchor point.

Subsequently, the artificial intelligence model training unit 220 may designate the labels and then calculate a loss function by summing loss weights of respective outputs (the positive anchor points and the negative anchor points), as shown in the following formula.

$$L = {λ}_{1} {L}_{P} + {λ}_{2} {L}_{B} + {λ}_{3} {L}_{C} \qquad [ Formula ]$$

Here, in the case of the positive anchor point, L_{B} may be a loss function for a bounding box length of the ground truth point, L_{C} may be a loss function for the centerness between the ground truth point and the positive anchor point, and each loss function may be expressed as the following formula.

$${L}_{B} = \frac{1}{I} {\sum }_{0}^{I} {\sum }_{0}^{J} {ℒ}_{DIoU} ( {B}_{i}^{𝔾} , {\hat{B}}_{j} ) \qquad [ Formula ]$$

$${L}_{C} = \frac{1}{I} {\sum }_{0}^{I} {\sum }_{0}^{J} {L}_{CE} ( {C}_{i}^{*} , {\hat{C}}_{j} )$$

That is, L_{B} is a DIoU loss value between the bounding box [symbol] of the ground truth point and the bounding box \hat{B}ⱼ of the predicted point, and L_{C} is a cross entropy loss of the centerness

$${C}_{i}^{*}$$

estimated from the predicted point and the centerness

$${C}_{i}^{*}$$

between the ground truth point and the positive anchor point.

Here, the centerness between the ground truth point and the positive anchor point may be calculated based on the following formula.

$${C}^{*} = 1 - \frac{{‖ {A}_{j} - {G}_{i} ‖}_{2}}{{d}^{2}} \qquad [ Formula ]$$

(Aⱼ is the set of the plurality of anchor points, Gᵢ is a set of the plurality of ground truth points, and d is a value obtained by converting a diagonal distance between a bounding box of the ground truth points and a bounding box of the anchor points into a Euclidean distance.)

Further, for a loss function L_{P} for classification training, the one-hot encoding of the probability of the head being present at the predicted point predicted from the artificial intelligence model for both positive and negative anchor points may be used. However, since a proportion of positive anchor points among all anchor points is relatively small, L_{P} may cause class imbalance as the probability of the positive anchor points is underestimated.

Therefore, the artificial intelligence model training unit 220 may add a cross entropy of the positive anchor point to a weighted cross entropy of all anchor points, as shown in the following formula.

$${L}_{P} = - \frac{β}{I} {\sum }_{0}^{I} {\sum }_{0}^{J} {L}_{CE} ( {P}_{i} , {\hat{P}}_{j} ) - \frac{1}{J} \{ α {\sum }_{0}^{I} {\sum }_{0}^{J} {L}_{CE} ( {P}_{i} , {\hat{P}}_{j} ) + ( 1 - α ) {\sum }_{0}^{I} {\sum }_{0}^{J} {L}_{CE} ( {P}_{i} , {\hat{P}}_{j} ) \} \qquad [ Formula ]$$

In addition, since the number of negative anchor points is relatively larger, the artificial intelligence model training unit 220 may adjust a scale of a cross-entropy weight using a hyperparameter α. Further, to prevent overestimation of the positive anchor points, a hyperparameter β may be used for a cross-entropy of the positive anchor points.

As a next configuration, the head localization unit 225 may localize a head of at least one person in the received image using the artificial intelligence model trained by the artificial intelligence model training unit 220.

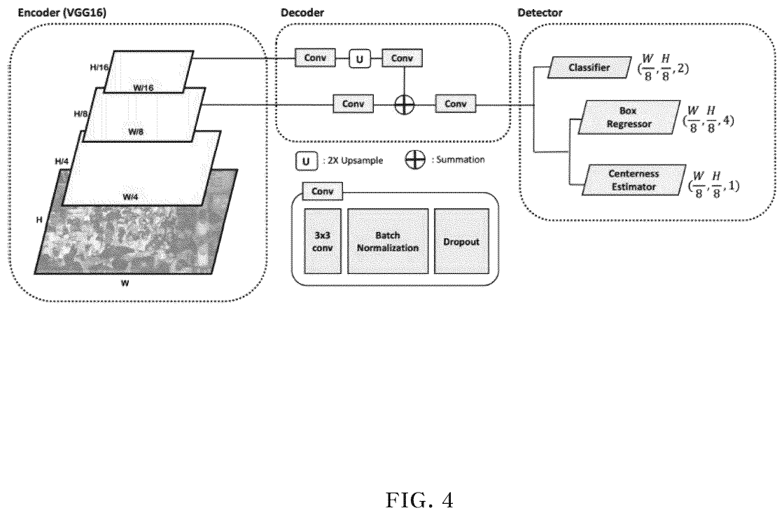

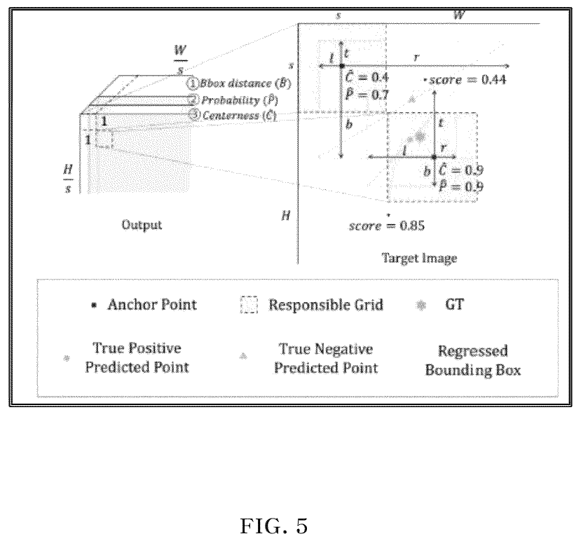

The artificial intelligence model according to the embodiment of the present invention will be described in detail with reference to FIGS. 4 and 5.

FIG. 4 is an illustrative diagram illustrating an artificial intelligence model according to an embodiment of the present invention, and FIG. 5 is an illustrative diagram illustrating an output value estimated from the artificial intelligence model according to the embodiment of the present invention.

Specifically, the head localization unit 225 may construct a feature pyramid structure by gradually downscaling the feature map extracted from the received image by a preset scaling ratio. For example, the head localization unit 225 may construct the feature pyramid structure by downscaling the feature map extracted from the image by a factor of two. This makes it possible for the head localization unit 225 to extract key features for each scale due to an increase in an accommodation area per pixel as a depth increases.

Further, the head localization unit 225 may fuse scale-specific features contained in the feature maps included in the feature pyramid structure into a feature map having a preset size for an original image through convolution, dilation, and sum operations. For example, the head localization unit 225 may fuse scale-specific features of images in the feature pyramid structure into a feature map that is ⅛ the size of the original image through a series of convolution, dilation, and sum operations.

Further, the head localization unit 225 may predict various types of values based on a feature map containing fused multi-scale features.

Specifically, the head localization unit 225 may estimate distances between left, right, upper, and lower boundary lines of the bounding box set for an object that is predicted to be a head of the person from a plurality of anchor points for the received image through the artificial intelligence model. That is, as illustrated in FIG. 5, the head localization unit 225 may predict distances l, r, t, and b between the left, right, upper, and lower boundary lines from the plurality of anchor points to a regressed bounding box set for a predicted object. As described above, a center point of the regressed bounding box does not need to be present within a responsible grid of the anchor point. Further, the anchor point needs to be located within the bounding box, and the center point of the bounding box may be outside the responsible grid of the anchor point. Thus, the head localization unit 225 may guarantee the reliability of the predicted point regardless of whether the head is present within or outside the grid.

Further, the head localization unit 225 may estimate the probability of the head being present at the predicted point corresponding to the center of the bounding box set for an object predicted to be a head of the person. That is, the head localization unit 225 may predict the probability of the head of the person being actually present at a predicted point corresponding to the center of the regressed bounding box set for the predicted object from the plurality of anchor points estimated from the artificial intelligence model as described above. Accordingly, even when the plurality of anchor points predict the same head center coordinates, the probabilities may have different values.

Further, the head localization unit 225 may estimate the centerness between the predicted point and the corresponding anchor point. That is, the head localization unit 225 may estimate the centerness representing a normalized distance between the predicted point and the corresponding anchor point. This allows the head localization unit 225 to estimate the reliability of the predicted point using the centerness.

The head localization unit 225 may calculate a score of the predicted point using the following formula and estimate center coordinates of a head of at least one person in the received image based on the calculated score of the predicted point.

$$score = \hat{P} \times \sqrt{\hat{C}} \qquad [ Formula ]$$

(where \hat{P} represents the probability, and Ĉ represents the centerness.)

Hereinafter, evaluation results of the artificial intelligence model of the detection server according to the embodiment of the present invention will be described.

### Dataset

The most widely used benchmark datasets, such as “ShanghaiTech,” “UCF-QNRF,” and “NWPU,” were used to evaluate the performance of the artificial intelligence model according to the embodiment of the present invention.

“Shanghai Tech” is divided into Type A (SHTA) and Type B (SHTB). “SHTA” mainly consists of images with extremely dense crowds, whereas “SHTB” consists of images with relatively sparse crowds. The respective types include 300 and 400 pieces of training data and 182 and 316 pieces of test data, respectively. An average resolution of the “SHTA” image is 589×868, which is smaller than other benchmark datasets, but includes an average of 501 head annotations. Further, all images in “SHTB” have a resolution of 768×1024.

“UCF-QNRF” includes 1201 pieces of training data sets and 334 pieces of test data, and includes various types of information such as various camera angles, change in light, and crowd density distribution, allowing UCF-QNRF to be used to create a crowd counting method. Further, “UCF-QNRF” is a large and generalized dataset with diverse head sizes across multiple environment images compared to the other benchmark datasets. Therefore, UCF-QNRF is used to pretrain the artificial intelligence model according to the embodiment of the present invention before fine-tuning in an evaluation phase.

“NWPU-crowd” is a largest crowd localization dataset consisting of 5,109 images with 2,133,375 annotations. “NWPU-crowd” is a generalized high-resolution dataset with an average resolution of 2191×3209 and 351 negative samples. This also exhibits a significant head shape variation and supports box-level annotations as well as point-level annotations.

### Hyperparameter, Data Augmentation, and Environment

An Adam optimization program with a learning rate of 1e-4 and a batch size of 16 was used during a training phase. Further, hyperparameters for the loss function were experimentally determined to be α=0.45, β=0.01, λ1=0.1, λ2=0.01, and λ3=0.01. Further, to prevent excessive processing costs and the occurrence of many negative anchor points among remaining anchor points, super-resolution image samples were downscaled to 1792×2304, which degraded overall performance.

To increase the input data, “Random Scaling” and “Flipping” were adopted. Further, training and evaluation of the artificial intelligence model were performed on a server with “NVIDIA RTX 3080Ti” and “Ubuntu LTS 20.04.”

To evaluate the artificial intelligence model of the present invention on the benchmark dataset, a mean absolute error (MAE) was measured and a root mean squared error (RMSE) was measured, as shown in the following formula. These are general measurement items for crowd calculation evaluation. In the following description, RMSE will be referred to as MSE by considering that most studies using the RMSE formula present a mean squared error (MSE).

$$MAE = \frac{1}{N} {\sum }_{n = 1}^{N} \vert {\hat{I}}_{n} - {I}_{n} \vert , \qquad [ Formula ]$$

$$MSE = \sqrt{\frac{1}{N} {\sum }_{n = 1}^{N} {( {\hat{I}}_{n} - {I}_{n} )}^{2}}$$

$$( N : Num . of test imgs , {I}_{n} , {\hat{I}}_{n} : Num . of GT and positive output on {n}^{th} img )$$

Further, a precision, recall, and F1 score of “NWPU,” that are commonly used metric for crowd position assessment were measured.

### Evaluation

The performance of a proposed crowd calculation method was evaluated based on “SHTA,” “SHTB,” and “UCF-QNRF.” Further, the crowd localization performance based on “NWPU” was evaluated. Since a head size attribute of a crowd image varies greatly with resolution, a proposed artificial intelligence model (PSL-Net) was divided into three types (PSL-Net (γ=18), PSL-Net (γ=24), and PSL-Net (γ=44)) based on the hyperparameter γ used in training. Therefore, the hyperparameter of PSL-Net (γ=18) was set to 18 in consideration of a relatively low image resolution and small head size, and the hyperparameter of PSL-Net (γ=44) was set to 44 in consideration of a high image resolution and large head. Considering the image resolution and head size between these, the hyperparameter of PSL-Net (γ=24) was set to 24. Here, the hyperparameters were determined through data analysis and hyperparameter grid search of each benchmark dataset.

TABLE 1

| | | SHTA | | SHTB | | QNRF | |
|---|---|---|---|---|---|---|---|
| Method | Strategy | MAE | MSE | MAE | MSE | MAE | MSE |
| VGG+GRP [40] | density map | 112.4 | 176.9 | 13.1 | 19.4 | 203.5 | 343.3 |
| MCNN [21] | density map | 110.2 | 173.2 | 26,4 | 41.3 | — | — |
| DM-Count [13] | density map | 59.7 | 95.7 | 7.4 | 11.8 | 85.6 | 148.3 |
| M-SFANet+M-SegNet [symbol] | density map | 57.5 | 94.4 | 6.3 | 10.0 | 87.6 | 147.7 |
| GauNet [14] | density map | 54.8 | 89.1 | 6.2 | 9.9 | 81.6 | 153.3 |
| [symbol] [27] | Image patch | 82.7 | 122.8 | 14.9 | 25.5 | 145.8 | 249.0 |
| TransCrowd [26] | Image patch | 66.1 | 105.1 | 9.3 | 16.1 | 97.2 | 168.5 |
| LAVITCrowd [25] | Image patch | 54.8 | 80.9 | 8.6 | 13.8 | 87.0 | 141.9 |
| PSLNet (γ = 18) | point detection | 49.9(8.8%) | 77.6(44.0%) | 6.0 | 9.9 | 92.9 | 156.4 |
| PSLNet (γ = 24) | point detection | 50.6 | 79.0 | 5.8(5.3%) | 9.2(9%) | 87.9 | 148.7 |
| PSLNet (γ = 44) | point detection | 50.4 | 77.9 | 6.1 | 10.0 | 85.5 | 144.4 |

[symbol]

indicates data missing or illegible when filed

TABLE 2

| | | SHTA | | SHTB | | QNRF | |
|---|---|---|---|---|---|---|---|
| Method | Strategy | MAE | MSE | MAE | MSE | MAE | MSE |
| Tiny Faces [2] | bbox detection | 237.8 | 422.8 | — | — | — | — |
| LSC-CNN[4] | bbox detection | 66.4 | 117.0 | 8.1 | 12.7 | 120.5 | 218.2 |
| PSDDN+[3] | bbox detection | 65.9 | 112.3 | 91 | 14. 2 | — | — |
| Topocount F8 | segmentation | 68.2 | 104.6 | 7.8 | 13.7 | 89 | 159 |
| Crowd-SDNet [12] | segmentation | 65.1 | 104.4 | 7.8 | 12.6 | — | — |
| RAZ [29] | point detection | 65.1 | 105.7 | 8.4 | 14.1 | 116 | 195 |
| F2PNet [10] | point detection | 52.7 | 85.0 | 6.2 | 9.9 | 85.3 | 154.5 |
| FGENet [11] | point detection | 51.6 | 85.0 | 6.3 | 10.5 | 85.2 | 158.7 |
| PSL-Net(γ = 18) | point detection | 49.9(3.2%) | 77.6(8.6%) | 6.0 | 9.9 | 92.9 | 1564 |
| PSL-Net(γ = 24) | point detection | 50.6 | 79.0 | 5.8(6.1%) | 9.2(6,9%) | 87.9 | 148.7 |
| PSL-Net(γ = 44) | point detection | 50.4 | 77.9 | 63 | 10.0 | 85.5 | 144.4(6.5%) |

Referring to Table 1, three types of artificial intelligence (PSL-Net) of the present invention outperform “Overcrowd” in “SHTA”, compared to a related artificial intelligence model that estimates the number of people in the crowd using a density map or an image patch. In particular, “PSL-Net (γ=18)” achieved ab MAE of 49.9 and an MSE of 77.6, thereby reducing the MAE by 4.9 and the MSE by 3.3, compared to the related artificial intelligence model. Further, all “PSL-Net” outperformed “GauNet” in “SHTB.” “PSL-Net (γ=24)” reduced the MAE by 0.4 and the MSE by 0.7. “PSL-Net (γ=44)” achieved the second-best performance in MAE and MSE which are 85.5 and 144.4 in “QNRF.”

Table 2 shows results of a comparison with related artificial intelligence models capable of ascertaining a position of a person using a bounding box or point detection, segmentation, and the like. Three types of “PSL-Net” are more excellent in “SHTA” than in “FGE-Net.” It can be seen that the “PSL-Net (γ=18)” having best-the best performance reduced the MAE by 1.7 and the MSE by 7.4 compared to related artificial intelligence models. and all “PSL-Net” outperformed the related artificial intelligence models in “SHTB.” “PSL-Net (γ=24)” can reduce the MAE by 0.4 and the MSE by 0.7. In “QNRF,” “PSL-Net (γ=44)” achieved the best performance in terms of MSE and the second-best performance in terms of MAE. While a difference from the highest MAE was only 0.3, the MSE was improved by 10.1.

As described above, performance was evaluated based on the “NWPU” test dataset. Since “NWPU” consists of high-resolution images, the performance of “PSL-Net (γ=44)” showing excellent performance at high resolutions was compared with other artificial intelligence models.

TABLE 3

| Methods | F1-Score | Precision | Recall |
|---|---|---|---|
| RAZ [29] | 0.599 | 0.666 | 0.543 |
| CLTR [13] | 0.694 | 0.676 | 0.685 |
| P2P-net [10] | 0.712 | 0.729 | 0.695 |
| PSL-Net(γ = 44) | 0.727 | 0.719 | 0.735 |

As shown in Table 3, in “PSL-Net”, the F1-score and recall are improved by 1.5% and 4.5%, compared to an existing point-based matching artificial intelligence model, thereby achieved the best F1-score and recall. It can be seen that, considering that “PSL-Net” outperforms “P2P-Net” despite having a 1% lower precision than “P2P-Net,” “PSL-Net” outperforms in both crowd counting and localization.

### Experiment

TABLE 4

| Score (Th > 0.5) | MAE | MSE |
|---|---|---|
| \hat{P} × Ĉ² | 50.96 | 79.58 |
| \hat{P} × Ĉ | 50.86 | 79.79 |
| $\dot{P} \times \sqrt{\dot{C}}$ | 49.97 | 77.67 |
| $\hat{P} \times \sqrt[3]{\hat{C}}$ | 50.14 | 78.01 |

### 1) Effects of Centerness as Score Weight

First, the effects of the centerness are examined as a weight for an inference score from experiments, as shown in Table 4 in which the centerness is scaled by either a square or a square root. As described above, the scale of the centerness is amplified by a square root and the centerness ranges from 0 to 1, and thus, the scale decreases by a square of the centerness. In conclusion, the proposed method showed better performance when the scale of the centerness was increased. This means that the centerness of a predicted point is as important as the probability. However, excessive amplification of the scale of the centerness may degrade performance, which ultimately implies that the probability is an essential element of classification. Therefore, the centerness may serve as an auxiliary weight for generating more reliable prediction in candidates closer to actual head coordinates.

TABLE 5

| Matching Cardinality | Distance metric | MAE | MSE |
|---|---|---|---|
| 1:1 | L2 distance | 52.66 | 80.36 |
| Partial N:1 | L2 distance | 55.87 | 86.54 |
| 1:1 | DIoU with PSL | 52.69 | 81.03 |
| Partial N:1 | DIoU with PSL | 49.97 | 77.67 |

### 2) Effects of Matching Process Configuration

As shown in Table 5, a metric method for a distance between the ground truth point and the anchor point in label assignment, and effects of matching cardinality were evaluated during the training of the proposed artificial intelligence model. In terms of distance metrics, a difference between the L2-distance used for matching in “P2P-Net” and a DIoUs of the artificial intelligence model according to the present invention is observed, and in terms of matching cardinality, a difference between one-to-one matching and partial many-to-one matching of the artificial intelligence model according to the present invention is observed. As seen in “P2P-Net,” sparse prediction leads to excessive increase in the number of samples. In the case of one-to-one matching, experimental results showed similar performance regardless of the distance metric. This is presumed to be because ground truth points are assigned anchor points depending on their distances in both metrics. Further, it can be seen that the reliability of crowd localization may be degraded because pairs that are far apart from each other may be included. On the other hand, in the case of the partial many-to-one matching, it is shown that there is a significant difference between using DIoU and using L2-distance since the performance is improved with DIoU and the performance is degraded with L2-distance. This result shows that a relative distance by DIoU is more effective than an absolute pixel-level distance by L2 distance when the artificial intelligence model according to the present invention allowing repeated anchor points for a single ground truth point is used.

TABLE 6

| label | F1-Score | Precision | Recall |
|---|---|---|---|
| Man-made Bbox Label | 0.615 | 0.568 | 0.671 |
| Pseudo Square Label(random) | 0.691 | 0.717 | 0.667 |
| Pseudo Square Label(static) | 0.727 | 0.719 | 0.735 |

### 3) Effects of Pseudo Square Label (PSL)

As shown in Table 6, an influence of the proposed PSL on the bounding box estimation is examined. In a study on a bounding box label, an experiment was conducted through a PSL generated by randomly selecting hyperparameters from natural numbers ranging from 18 to 44, a manually annotated artificial label for an individual head provided in a “NWPU” benchmark dataset, and a PSL generated by setting the hyperparameter to 44 through the artificial intelligence model according to the present invention. As a result, the proposed method achieved the best performance based on all metrics using PSL. In terms of the F1 score, the artificial intelligence model according to the present invention was improved by 3% compared to random PSL and by 11% compared to artificial labels.

### Analysis

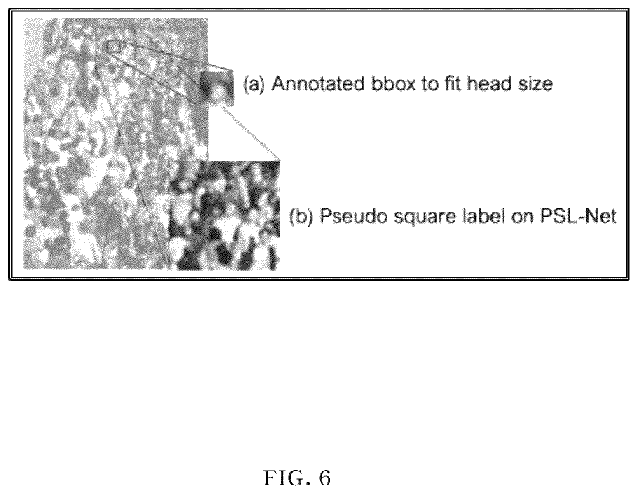

FIGS. 6 to 8 are illustrative diagrams illustrating performance of the artificial intelligence model according to the embodiment of the present invention.

As illustrated in FIG. 6, training using labels a is difficult without contextual information from background because it is difficult to clearly identify the presence of a person when annotations are based on a head size. Therefore, the present invention demonstrates that no optimization or annotation is required to adapt the pseudo square label to the head size demonstrated in previous studies. Meanwhile, since there are several instances that do not require background information in the same pseudo square label, large hyperparameters make the proposed method difficult to supervise. Therefore, assignment of an appropriate value to the hyperparameter is essential in the present invention.

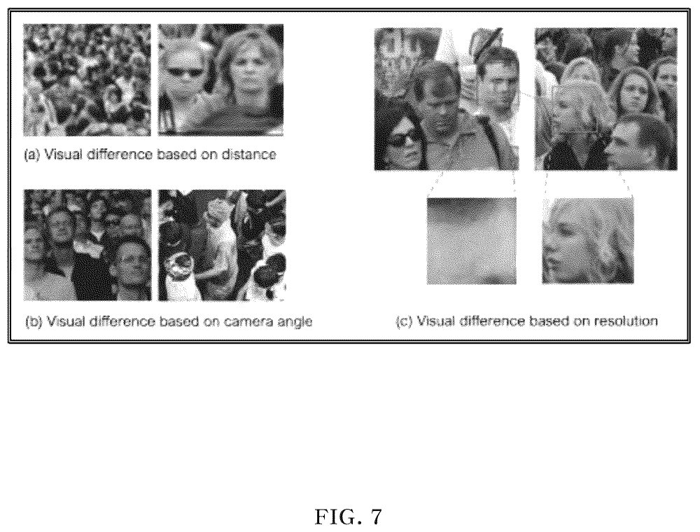

The respective benchmark datasets differ in distance, angle, and resolution attributes having an influence on a head size distribution in a crowd image. As illustrated in FIG. 7(a), different scales of the same image are observed depending on a distance from the camera to a person. Even with the same resolution, a prediction error in a left image may greatly degrade the performance due to high image density and insufficient visual features for the person. On the other hand, since a person may be intuitively identified from a right image, the prediction error has a minimal influence on the overall performance. It can be seen from FIG. 7(b) that the visual features of the head greatly differ despite their similar sizes depending on a camera angle. FIG. 7(c) shows two images with different resolutions. It can be seen that, although the head sizes in both the images are similar, it is more difficult to extract visual features of the head from the left high-resolution image (560×560) than from the right low-resolution image (160×160) cropped as a patch. Therefore, different hyperparameters are assigned to the respective benchmark datasets due to information imbalance caused by the aforementioned attributes.

As described above, “PSL-Net” presents supervised experimental results with three different hyperparameters. Each hyperparameter of “PSL-Net” may be determined through a grid search from 16 to 48 in consideration of attributes of each benchmark dataset. The results showed that “PSL-Net (γ=18)” showed excellent performance in “SHTA” with high crowding density and low resolution, while “PSL-Net (γ=24)” showed excellent performance in “SHTB” with low resolution but a relatively large head due to low density. “PSL-Net (γ=44)” showed excellent performance in “UCF-QNRF” with a relatively large head and high resolution.

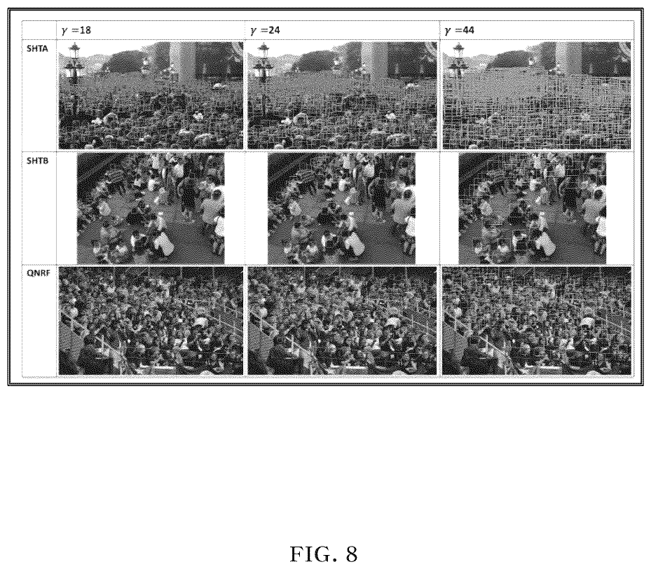

In FIG. 8, three types of PSLs that achieve optimal performance in each benchmark dataset are visualized. In particular, the results show that the PSL in representative images of respective benchmarks include generally visible features, indicating that the most of crowds in “SHTA,” “SHTB,” and “QNRF” images are covered, but the PSLs do not overlap greatly, with γ=18, 24, and 44. It can be seen that, because the “QNRF” image has a very high resolution, PSL is about twice as large as “SHTA” and is visually appropriate.

Hereinafter, hardware for implementing logical components of the detection server as described above will be described in greater detail.

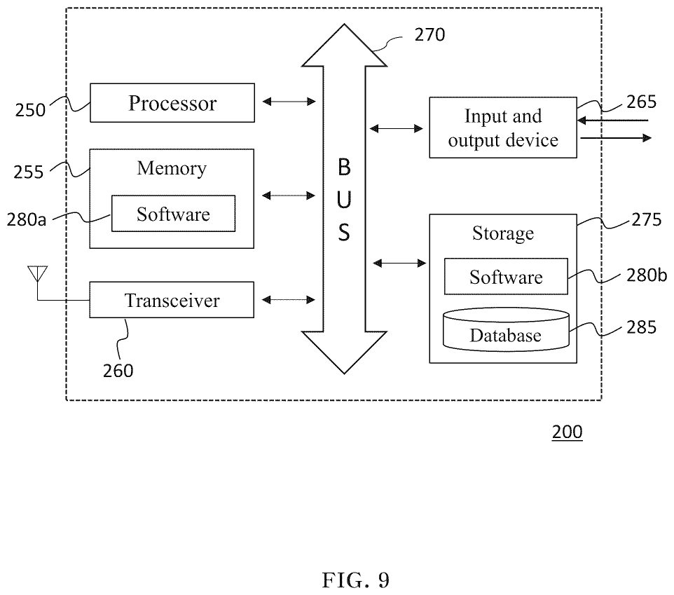

FIG. 9 is a hardware configuration diagram illustrating the detection server according to the embodiment of the present invention.

As illustrated in FIG. 9, the detection server 200 may include a processor 250, a memory 255, a transceiver 260, an input and output device 265, a data bus 270, and storage 275.

The processor 250 may implement operations and functions of the detection server 200 based on instructions according to software 280a implementing a method of localizing heads of people in a crowd, which resides in the memory 255.

The software 280a implementing the method of localizing heads of people in a crowd according to embodiments of the present invention may be loaded into the memory 255.

The transceiver 260 may transmit and receive data to and from the video collection device 100.

The input and output device 265 may output data necessary for an operation of the detection server 200.

The data bus 270 may be connected to the processor 250, the memory 255, the transceiver 260, the input and output device 265, and the storage 275, to serve as a communication passway for data transfer between the respective components.

The storage 275 may store an application programming interface (API), a library file, a resource file, and the like necessary for execution of the software 280a implementing the method of localizing heads of people in a crowd according to embodiments of the present invention. Further, the storage 275 may store software 280b and a database 285 implementing the method according to embodiments of the present invention.

According to an embodiment of the present invention, the software 280a and the software 280b for implementing the method of localizing heads of people in a crowd, which resides in the memory 255 or is stored in the storage 275, may be a computer program recorded on a recording medium that causes the processor to execute the steps of: training the artificial intelligence (AI) model; receiving an image captured by a camera requiring head localization; and detecting center coordinates of a head of at least one person from the received image based on the artificial intelligence model.

More specifically, the processor 250 may include an application-specific integrated circuit (ASIC), another chipset, a logic circuit, and/or a data processing device. The memory 255 may include a read-only memory (ROM), a random access memory (RAM), a flash memory, a memory card, a storage medium, and/or another storage device. The transceiver 260 may include a baseband circuit for processing wired and wireless signals. The input and output device 265 may include an input device such as a keyboard, a mouse, and/or a joystick; a video output device such as a liquid crystal display (LCD), an organic light-emitting diode (OLED), and/or an active matrix OLED (AMOLED); and a printing device such as a printer or a plotter.

When the embodiments included in the present specification are implemented in software, the above-described method may be implemented as a module (process, function, or the like) that performs the above-described function. The module may reside in the memory 255 and be executed by the processor 250. The memory 255 may be internal or external to the processor 250 and may be connected to the processor 250 via various well-known means.

Respective components illustrated in FIG. 9 may be implemented by various means, such as hardware, firmware, software, or a combination thereof. In the case of hardware implementation, an embodiment of the present invention may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, and microprocessors.

Further, when the components are implemented by firmware or software, an embodiment of the present invention may be implemented in the form of, for example, a module, procedure, or function that performs the functions or operations described above, and recorded on a recording medium readable by various computer means. Here, the recording medium may include program instructions, data files, data structures, and the like alone or in combination. The program instructions recorded on the recording medium may be those specially designed and configured for the present invention, or may be those known and usable by those skilled in the art of computer software. For example, the recording medium includes a magnetic medium such as a hard disk, a floppy disk, or a magnetic tape, an optical medium such as a compact disk read only memory (CD-ROM) or a digital video disc (DVD), a magneto-optical medium such as a floptical disk, and a hardware device specially configured to store and execute program instructions such as a ROM, a RAMs, and a flash memory. Examples of the program instructions may include not only machine language code generated by a compiler, but also high-level language code that can be executed by a computer using an interpreter or the like. Such hardware devices may be configured to operate as one or more software programs to perform an operation of the present invention, and vice versa.

Hereinafter, a method of localizing heads of people in a crowd according to an embodiment of the present invention will be described in detail.

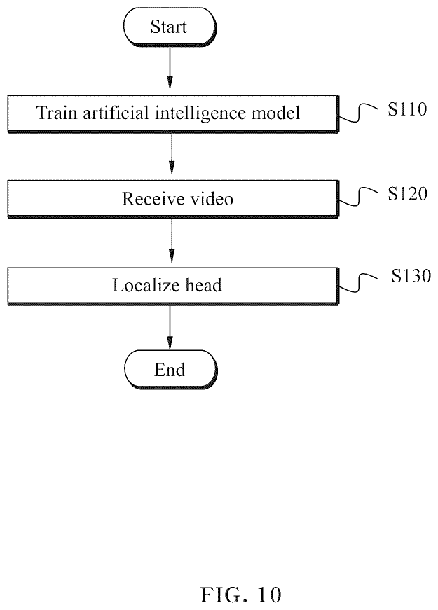

FIG. 10 is a flowchart illustrating a method of localizing heads of people in a crowd according to an embodiment of the present invention.

Referring to FIG. 10, in step S110, the detection server may train an artificial intelligence (AI) model.

Specifically, the detection server matches at least one anchor point for a center of a grid formed by dividing the training image in the same size to a plurality of ground truth points for a center of a head of a person appearing in the training image, in which the detection server may perform non-replacement matching in ascending order of a difference in the probability of the head being present at the predicted point predicted from the artificial intelligence model based on a distance IoU (DIoU) loss value between the at least one anchor point and the plurality of ground truth points, and the anchor point. In this case, when the ground truth point fails to be matched with at least one anchor point, the detection server may perform matching by extracting in a non-replacement manner an anchor point with a smallest difference in the probability of the head being present at the predicted point predicted from the artificial intelligence model based on a distance IoU (DIoU) loss value between at least one of already matched anchor points and the ground truth point failing to be matched and the anchor point.

Next, in step S120, the detection server may collect videos from the video collection device in real time.

Next, in step S130, the detection server may localize a head of at least one person in the received image using the artificial intelligence model trained in step S110.

As described above, the present specification and drawings disclose preferred embodiments of the present invention, but it will be apparent to those skilled in the art that other variations based on the technical spirit of the present invention can be made in addition to the embodiments disclosed herein. Further, although specific terminology is used in the present specification and drawings, the terminology is used in a general sense to facilitate the understanding of the present invention and is not intended to limit the scope of the present invention. Therefore, the detailed description should not be construed as limiting in any respect and should be considered illustrative. The scope of the present invention should be determined by a reasonable construing of the appended claims, and all changes that fall within the scope of equivalents of the present invention are encompassed within the scope of the present invention.

### DETAILED DESCRIPTION OF MAIN ELEMENTS

100: Video collection device
200: Detection server
205: Communication unit
210: Input and output unit
215: Storage unit
220: Artificial intelligence model training unit
225: Head position localization unit

What is claimed is:

1. A method of localizing heads of people in a crowd, comprising:
training, by a detection server, an artificial intelligence (AI) model;
receiving, by the detection server, an image captured by a camera requiring head localization; and
detecting, by the detection server, center coordinates of a head of at least one person from the received image based on the artificial intelligence model,
wherein the training includes matching at least one anchor point for a center of a grid formed by dividing a training image into equal-sized areas to a plurality of ground truth points for a center of a head of a person appearing in the training image and performing label assignment to train the artificial intelligence model, non-replacement matching being performed in ascending order of a difference in probability of the head being present at a predicted point predicted from the artificial intelligence model based on a distance IoU (DIoU) loss value between the at least one anchor point and the plurality of ground truth points, and the anchor point.

2. The method of localizing heads of people in a crowd of claim 1, wherein the training includes performing matching by extracting in a non-replacement manner an anchor point with a smallest difference in the probability of the head being present at the predicted point predicted from the artificial intelligence model based on a distance IoU (DIoU) loss value between at least one of already matched anchor points and the ground truth point failing to be matched and the anchor point, when the ground truth point fails to be matched with the at least one anchor point.

3. The method of localizing heads of people in a crowd of claim 1, wherein the training includes matching the at least one anchor point to the plurality of ground truth points based on a cost matrix according to the following formula.
$$\begin{matrix}M ( 𝔸 , 𝔾 ) = {ℒ}_{DIoU} ( 𝔸 , 𝔾 ) - {\hat{P}}_{j} \\ = 1 - IoU ( {B}_{j}^{𝔸} , {B}_{i}^{𝔾} ) + \frac{{‖ {A}_{j} - {G}_{i} ‖}_{2}}{{d}^{2}} - {\hat{P}}_{j}\end{matrix} \qquad [ Formula ]$$
(where [symbol] is the ground truth point, [symbol] is the anchor point, \hat{P}ⱼ is the probability of the head being present at the predicted point predicted from the artificial intelligence model based on the anchor point, Aⱼ is a set of a plurality of anchor points, Gᵢ is a set of the plurality of ground truth points, [symbol] is a set of anchor point bounding boxes, [symbol] is a set of ground truth point bounding boxes, and d is a value obtained by converting a diagonal distance between a bounding box of the ground truth points and a bounding box of the anchor points into a Euclidean distance.)

4. The method of localizing heads of people in a crowd of claim 3, wherein the training includes dividing the anchor points into a positive anchor point matched with the ground truth point and a negative anchor point not matched with the ground truth point, and training the artificial intelligence model based on the positive anchor point and the negative anchor point.

5. The method of localizing heads of people in a crowd of claim 4, wherein the training includes assigning labels for a length of the bounding box of the ground truth point, one-hot encoding of the probability of the head being present at the predicted point predicted from the artificial intelligence model based on the positive anchor point, and centerness between the ground truth point and a positive anchor point to the positive anchor point.

6. The method of localizing heads of people in a crowd of claim 5, wherein the training includes calculating the centerness based on the following formula.
$${C}^{*} = 1 - \frac{{‖ {A}_{j} - {G}_{i} ‖}_{2}}{{d}^{2}} \qquad [ Formula ]$$
(Aⱼ is a set of the plurality of anchor points, Gᵢ is a set of the plurality of ground truth points, and d is a value obtained by converting a diagonal distance between the bounding box of the ground truth points and the bounding box of the anchor points into a Euclidean distance.)

7. The method of localizing heads of people in a crowd of claim 4, wherein the training includes assigning a label for one-hot encoding of the probability of the head being present at the predicted point predicted from the artificial intelligence model based on the negative anchor point to the negative anchor point.

8. The method of localizing heads of people in a crowd of claim 1, wherein the artificial intelligence model constructs a feature pyramid structure by gradually downscaling feature maps extracted from each frame of the received image by a preset scaling ratio, and fuses scale-specific features contained in the feature maps included in the feature pyramid structure into a feature map having a preset size for the received image through convolution, dilation, and sum operations.

9. The method of localizing heads of people in a crowd of claim 8, wherein the detecting includes estimating the center coordinates of the head of the at least one person in the received image based on distances between left, right, upper, and lower boundaries of a bounding box set for an object predicted to be a head of a person from a plurality of anchor points in the received image, a probability of the head being present at the predicted point corresponding to a center point of the bounding box set for the object predicted to be the head of the person, and centerness between the predicted point and the anchor point.

10. The method of localizing heads of people in a crowd of claim 9, wherein the detecting includes calculating a score of the predicted point based on the following formula, and estimating the center coordinates of the head of the at least one person in the received image based on the calculated score of the predicted point.
$$score = \hat{P} \times \sqrt{\hat{C}} \qquad [ Formula ]$$
(where \hat{P} is the probability and Ĉ is the centerness)

11. A computer program connected to a computing device comprising: a memory, a transceiver, and a processor configured to process instructions residing in the memory, the computer program causing the processor to execute:
training an artificial intelligence (AI) model;
receiving an image captured by a camera requiring head localization; and
detecting center coordinates of a head of at least one person from the received image based on the artificial intelligence model,
wherein the training includes matching at least one anchor point for a center of a grid formed by dividing a training image into equal-sized areas to a plurality of ground truth points for a center of a head of a person appearing in the training image and performing label assignment to train the artificial intelligence model, non-replacement matching being performed in ascending order of a difference in probability of the head being present at a predicted point predicted from the artificial intelligence model based on a distance IoU (DIoU) loss value between the at least one anchor point and the plurality of ground truth points, and the anchor point.
